(19) United States
(12) Patent Application Publication
(10) Pub. No.: US 2012/0027906 A1
(43) Pub. Date: Feb. 2, 2012

(54) Method for producing a freeze-dried instant meat product from at least one piece of meat and other optional ingredients

(75) Inventors: Peter Eisner, Freising (DE); Erwin Denker, Hechendorf-Murnau (DE); Klaus Mueller, Freising (DE); Christian Zacherl, Freising (DE); Andreas Gebhat, Freising (DE)

(73) Assignee: FRAUNHOFER GESELLSCHAFT ZUR FOEDERUNG DER ANGEWANDTEN FORSCHUN

(21) Appl. No.: 13/200,772

(22) Filed: Oct. 1, 2011

Related U.S. Application Data
(63) Continuation of application No. PCT/DE2009/000432, filed on Apr. 3, 2009.

(51) Int. Cl. A23B 4/037; A23L 1/317; A23L 1/31; A23L 1/325; A23B 4/02; A23B 4/18; A23L 1/315

(52) U.S. Cl. 426/541; 426/385; 426/641

(57) ABSTRACT

A method for producing a freeze-dried instant meat product from at least one piece of meat and other optional ingredients. The meat is cooked, blanched, boiled, roasted, or baked during a precooking process before being freeze-dried.

### RELATED APPLICATIONS

This application is a continuation of International application PCT/DE2009/000432 filed on Apr. 3, 2009, which is incorporated in its entirety by this reference.

### FIELD OF THE INVENTION

The invention relates to a method for producing a freeze-dried instant meat product from at least one piece of meat and other optional ingredients by providing meat and optional additional ingredients, and cooking, broiling, simmering, roasting or baking the meat in a pre-cooking process and then freeze-drying and the freeze-dried instant meat product produced according to the method.

### BACKGROUND OF THE INVENTION

Freeze-drying extracts water from the fresh meat and thus produces a dry instant meat product which can be returned into a consistency which is very similar to the consistency of fresh meat after water is added again (rehydration). A dry product of this type that is based on meat which is only ready to use after a rehydration is subsequently designated as an instant meat product.

Freeze-dryers include a drying chamber, heatable or coolable trays or racks within the drying chamber, a refrigeration machine, an intermediary valve, a vacuum pump and ventilation valves. The process of freeze-drying then runs as follows:

During freezing, the water included in the object to be freeze-dried is completely frozen into ice. Opening the intermediary valve activates the condenser and the vacuum pump for the main drying process. During the main drying process, the ice produced during freezing is removed from the object. The vacuum pump generates a vacuum in the drying chamber through which the water sublimates; this means the water transitions from a solid state (ice) into a gaseous state. Through the sublimation, the water exits from the object. The heat energy required for this reaction is generated by heatable floors or racks in the drying chamber. The exiting water vapor then migrates into the condenser cavity cooled by the refrigeration machine. Through the cold, the water vapor transforms into ice and precipitates at the walls of the condenser cavity. In order to check whether the process of freeze-drying is totally completed the intermediary valve is closed. In case the vacuum is maintained during closing the intermediary valve, the drying is completed. However, when there is residual humidity, the main drying process has to be started again. During the main drying process, a large percentage of the water has been removed from the object which then, however, can still include bonded water. The bonded water is then also converted into gas and removed in the course of a post-drying process.

A method according to the invention for freeze-drying ground meat is described in GB 989 545 A, wherein fresh ground meat and ingredients like onions, eggs, tomato paste are mixed with one another and the mixture is then freeze-dried.

Instead of working ingredients like spices directly into the ground meat and to then freeze-drying the mixture, it is better in some cases to freeze-dry the meat and the ingredients separately from one another or to only freeze-dry the meat and to mix meat and ingredients only during the rehydration or in the course of a joint cooking process.

This however can cause a problem in as far as the meat on the one hand side and the ingredients on the other hand side can have different preparation or cooking temperatures and different preparation and cooking times so that the meat or the ingredients have to be prepared separately from one another during the preparation or cooking process or the meat and the ingredients have to be prepared together, but one of the components is not prepared under optimum conditions. This problem relates in particular to meat based sauces and ragus, in particular for noodle dishes with a rather large number of base components like meat, tomato paste, spices, noodles, etc. wherein the particular components often have different preparation times and temperatures.

### BRIEF SUMMARY OF THE INVENTION

Thus, it is an object of the present invention to provide a method for producing a freeze-dried instant meat product as recited supra through which in particular mixes of meat with additional ingredients like meat based sauces or ragu can be prepared in an economical and quick manner.

### DETAILED DESCRIPTION OF THE INVENTION

The invention is based on the idea that meat is cooked, broiled, simmered, roasted or baked in a pre-cooking process before freeze drying.

The pre-cooking process for the meat is provided so that the core temperature of the meat is more than 75° C.

Pre-cooking meat for freeze-dried instant meat products with plural content materials like meat and ingredients like a spice mix has the advantage that both, the meat and the ingredients have the same preparation time and in particular can be prepared or cooked together. Accordingly, the pre-cooking time or the pre-cooking temperature for the meat is advantageously selected so that the remaining residual cooking time in re-hydrated condition corresponds to the total cooking time of the remaining ingredients. This facilitates a simple preparation and the quickest possible preparation time for the rehydrated meat.

Another advantage of pre-cooking is energy savings through the water already being removed from the meat during pre-cooking. The water already removed from the meat before freeze-drying (depending on the method between 15 and 25% by weight) does not have to be lyophilized or removed by comparatively expensive freeze-drying. Thus, original and not pre-cooked meat masses have a water content of 73% by weight up to 74% by weight, pre-cooked meat masses depending on the pre-cooking method, however, only have a water content of 50% to 65% by weight.

Another advantage of the pre-cooking process is the far-going denaturization and remaining of the meat inherent proteins within the meat matrix which has positive influences upon the sensory properties and the quality of the final product.

The instant meat product according to the invention, or a meat that is ready for use or consumption is produced in detail by using the subsequently described method:

In particular pork, beef, poultry or fish meat is a suitable base material by itself or as a mix. The meat can be pre-mixed with spices, vegetables or other ingredients before freeze-drying. Alternatively the ingredients are freeze-dried separate from the meat and are only mixed with the meat during rehydration or preparation. Then the ingredients are placed into the common packaging but separately from the freeze-dried meat. The ingredients or the ingredient mix is then separately packaged within the packaging and is provided as a food material ready to eat after rehydration and heating. Optionally, the freeze-dried meat can also be packaged together with the ingredient mix in a common packaging.

Low Oxidation Pre-Treatment

In order to achieve a particularly high amount of naturalness (water bonding) of the meat proteins, fresh meat is freeze-dried in a gentle manner after adding an oxidation retarding agent (antioxidant). A meat freeze-dried in this manner furthermore has excellent taste properties. Particular sensory advantages with respect to smell and taste are achieved when the instant meat product includes antioxidant components that are distributed in the most even manner possible, in particular in the form of plant extracts.

For a particularly even distribution of antioxidants or of an antioxidant in the meat or at the meat it is advantageous to add one or plural amphiphile or lipophile substances to the meat before freeze-drying, so that according to an advantageous embodiment, the instant ground meat product also includes portions with these additives. A substance is designated as lipophile, which is easily soluble in fats or oils. Amphiphile substances are at least partially soluble in water and also in lipophile substances.

Typically an antioxidant like, for example, e.g. rosemary extract is added to meat products in order to reduce oxidation processes. However, for ground meat due to the large product surface and the fine distribution of the oxidation sensitive meat fat, the distribution of the antioxidant is very difficult.

This problem is solved through thinning the oxidant or the oxidants in a fat phase that is added to the already existing base fat content of the fresh meat, wherein the fat phase is gradually worked into the ground meat in increments or which are mixed with larger meat pieces or applied to the meat pieces.

Thus, it is apparent that this way finely-distributed antioxidants are directly adsorbed at the fat particles or introduced into the fat particles and thus can become effective at the most oxidation sensitive spots of the meat. A reduced oxidation propensity is measurable at the instant meat products produced in this manner.

It is particularly advantageous that the antioxidants or the antioxidant are distributed in a fat phase with a high percentage of saturated fatty acids. Thus, a long availability of the antioxidant in the meat can be assured. It is also possible to use amphiphile materials like alcohols or other materials like combinations of mono-/diglycerides.

Natural or synthetic substances can be used as antioxidants. Using natural antioxidants like rosemary extract, alpha-tocopherol and gamma-tocopherol is particularly advantageous.

The antioxidant pretreatment is used according to an exemplary embodiment, but it is not mandatory.

Pre-Cooking

Pre-cooking can be provided in two variants depending on the desired result.

Variant 1 (Ground Meat)

Ground meat according to the requirements of the end product or characteristically cut meat is filled according to the antioxidative treatment recited supra into suitable guts, shells or molds and cooked, broiled, simmered or baked in a vapor phase, hot air, water bath or other suitable media until a desired cooking point is reached, for example, when a core temperature of the ground meat is more than 75° C. Heat resistance and heat permeability as properties of the guts, jackets or molds are prerequisites.

Shortly after the pre-cooking process, the ground meat which is still hot is removed from the guts in order to separate the particles agglomerated at one another through the cooking process through a cutter or other suitable devices before cooling down.

Variant 2 (Meat Pieces)

As an alternative to variant 1, meat is not only used as ground meat but in entire larger pieces and cooked, broiled or simmered in suitable media until the desired pre-cooking point is reached. The piece size of the meat is then essentially maintained according to this embodiment until the packaging is performed.

Alternatively, according to the pre-cooking process, the meat can be cut either in still heated condition or in already cooled down condition through a meat grinder, a cutter or other suitable devices to a desired characteristic size or granulation to form ground meat.

The optional application or introduction of antioxidants (c.f. oxidation retarding pretreatment) onto the meat or into the meat in this case is performed before cooking and/or after cutting the meat into ground meat in order to protect the surfaces newly formed after cutting against oxidation.

As an additional alternative, larger meat pieces, ground meat or characteristically cut meat can be pre-cooked to the desirable cooking point, for example, through simmering or frying. A subsequent cutting, however, is not required anymore then. During frying, large amounts of proteins that are indigenous to the meat are released from the meat matrix and their denaturalization then occurs outside of the meat matrix. This leads to a grey coloring of the denaturalized proteins and thus to a formation of murky substances which remain visible in the end product like, for example, in sauces.

Forming Ground Meat Molded Blanks

Particularly advantageously the meat is processed further as a pre-cooked ground meat that is mixed with antioxidants and in particular formed into small size ground meat molded blanks in not yet frozen condition.

Thus, according to GB 589 545 A, larger amounts of ground meat, for example, approximately 14 kilos of ground meat, are evenly distributed on trays of the drying chamber. This facilitates freeze-drying a rather large cohesive coherent mass of ground meat which causes a low freeze-drying speed. In order to achieve a freeze-drying speed that is acceptable for freeze-drying on an industrial scale, however, the energy used for the freeze-drying process would have to be substantially increased, which is not economical.

Thus, a projection surface of a ground meat molded blank on a rack or a tray of the drying chamber of the freeze-dryer can have a maximum dimension like a diameter or an edge length of 2 cm to 16 cm and with respect to the rack or the base, a maximum height of 1 cm to 4 cm.

The projection surface defines the outline of the ground meat molded blank, wherein the outline is created when an imaginary pen is that is run about the ground meat molded blank orthogonal to the rack receiving the meat molded blank and the circumference line created is drawn onto the rack.

For example, more or less regular, cuboid, square or cylindrical molded blanks can be produced as a starting product for the freeze-drying process, but also molded blanks with irregular shapes, for example, in the shape of a pile.

For cuboids or cubes, the projection surface is a rectangle or a square, wherein the greatest edge length of the rectangle is its length.

In essentially cylindrical ground meat blanks as they are used, for example, for hamburger patties or meatloaves, the diameter of the circular projection surface has to be used. Also, cylindrical elongated and sausage-like blanks are conceivable which contact the rack or the tray with their enveloping surfaces, like, for example, ground meat sausages for Cevapcici. In this case, the largest dimension of the projection surface is formed by the length of the cylindrical ground meat roll in axial direction.

Last, but not least also spherical ground meat blanks can be used, for example, in the form of meat balls as they are served, for example, with spaghetti. Ball shaped structures of this type due to their rather soft consistency, differently from a ball shape, are slightly flattened. As a largest dimension of the projection surface of the diameter of the ball has to be used.

Overall it is advantageous that such ground meat blanks which are typically industrially produced are already brought into the shape in which they are consumed later on while they are still in a soft and easily moldable configuration in order to then be freeze-dried in this shape.

The ground meat mass therefore does not have to be shaped in freeze-dried and hard condition as it is the case, for example, in GB 989 545 A where a rather large ground meat volume is spread out plate shaped on the racks or trays and the final shape only has to be generated through cutting after freeze drying, for example, through saw cutting.

Thus in an irregular pile, the largest dimension of the projection surface of the pile on the rack shall also be in a range between 2 cm and 16 cm. Since the height extension of such a pile is irregular the greatest height of the pile should be in a range between 1 cm and 4 cm.

Thus, it is important that sufficient space is provided between the particular molded blanks arranged separately from one another on the racks or on a rack in order for the vacuum or the heat to be able to impact a portion of the surface of the molded blanks that is as large as possible. Since the racks of freeze dryers are typically configured with as perforated plates and thus are provided with pass through openings, the atmosphere in the drying chamber can also reach the ground meat molded blanks from their bottoms.

When ground meat molded blanks have such dimensions during freeze drying, this yields a rather high freeze drying speed which makes the freeze drying process very economical. The freeze-dried ground meat molded blanks can be hydrated quickly and have good sensory properties.

When the dimensions of the ground meat molded blanks in the freeze dryer are smaller and, for example, the greatest edge length or the diameter goes below 2 cm or the greatest height goes below 1 cm, this yields a smaller rehydration speed after freeze drying compared to ground meat molded blanks sized according to the invention. Furthermore also the degree rehydration, this means the capability to absorb water is lower.

For the greatest edge lengths or diameters of more than 16 cm or for a greatest height of more than 4 cm the freeze drying speed is significantly reduced which causes non-economical freeze drying and is therefore uneconomical as stated supra.

Ground meat molded blanks of this type have a mass in a range of 5 g to 1000 g before freeze drying.

Even better properties with respect to drying throughput, rehydration speed, degree of rehydration and product quality can be obtained when the projection surface of the ground meat molded blank on the rack of the freeze dryer has a maximum dimension like a diameter or a edge length of 3 cm-5 cm and with respect to the rack a greatest height of 2 cm-4 cm. The mass of a ground meat molded blank of this type then is in a range of 20 g-100 g.

With respect to the mass-surface ratio of a ground meat molded blank arranged on the rack before freeze drying, this means a ratio of its mass to its surface in a range of 1 kg/m² to 7 kg/m² is favorable.

Thereafter the ground meat or the characteristically cut meat or the ground meat molded blanks are cooled or frozen as quickly as possible. Thus, a cooling to

0° C. to −1° C. is desirable. This process will be described infra in more detail.

Freeze Drying

Freeze drying is a particularly gentle type of drying in order to remove water from the ground meat molded blanks as quickly as possible. Freeze drying or lyophilisation or sublimation drying is a drying of objects which are typically already in frozen condition. This means that the ground meat including water is freeze-dried and subsequently placed into the drying chamber of a freeze dryer. Therein it is exposed to a vacuum of less than 6 mbar. Under the influence of the vacuum the frozen water does not go into liquid state any more but it directly transitions from ice into vapor during the entire drying process (sublimation).

It has proven advantageous in particular when the preferably precooked ground meat molded blanks are not put into the drying chamber of the freeze dryer in frozen condition, but in partially or not frozen condition. In order to extract sufficient energy and humidity from the ground meat molded blanks through a quick generation of the vacuum in the drying chamber so that they are freeze-dried during the drying process.

Thus on the one hand side the proteins in the ground meat are treated gently and the water binding capacity of the dry product is maintained in a better manner than when a prior freeze drying is performed. On the other hand side a shorter processing or working time is feasible because the typical freezing phase of the fresh ground meat in freezers can be omitted. The shorter processing time of the ground meat reduces the growth of microorganisms and the occurrence of oxidation processes which can create rancidness. Furthermore color changes of the drying material are reduced and the water binding is influenced in a positive manner.

Alternatively the pre cooked ground meat molded blanks can also be inserted into the drying chamber of the freeze dryer in completely frozen condition and the vacuum can then be generated.

Drying and storing at a residual humidity or residual water contents below 5% by weight, better below 3% by weight is advantageous with respect to the rehydration capability. Thus it is apparent that the water absorption during constitution occurs quicker due to a higher osmotic pull.

It is also apparent that adding 0.5-1.5% salt (NaCl) before freeze drying has no negative effect upon the drying speed, though a higher water binding capability is achieved when adding salt. The freeze-dried instant meat product obtained through the method described is then characterized by the following properties:
the water content is smaller than 5% by weight, in particular smaller than 3% by weight;
the meat protein content is greater than 75% by weight, in particular greater than 85% by weight with reference to the dry mass; and
the meat proteins have such a high naturalness that the dry instant meat product can absorb so much water that the water content in the rehydrated meat is even higher than in the fresh meat.

It is advantageous to package the freeze-dried ground meat molded blanks and possibly additional ingredients under exclusion of light and CO₂ in a vapor, oxygen and light proof packaging under a protective gas atmosphere. It has proven particularly advantageous to perform the packaging in an atmosphere of 70% N₂ and 30% CO₂.

Rehydrating

When rehydrating freeze-dried ground meat molded blanks produced according to the method recited supra the water bonding was high enough so that 1%-3% more water could be bonded than was included in the original fresh ground meat. In spite of the greater water content products could be obtained that were comparable with fresh ground meat with respect to their haptic and sensory properties.

Thus the freeze-dried ground meat molded blanks were poured over with a respective amount of cold water and heated. After cooking for approximately 2 minutes at 80° C. to 90° C. they were ready for consumption. Preparation is simplified in particular in combination with a spice mix which facilitates an application in commercial kitchens.

It has become apparent that an advantageous overall effect is achieved through combining the precooking process with freeze drying pre cooked ground meat molded blanks in the characteristic dimensions described supra, since the pre cooking process reduces the cooking time required after rehydration and the selected sizing of the freeze-dried ground meat molded blanks facilitates a very quick hydratability so that overall a low preparation time of the instant meat product is achieved which in particular improves the acceptance of an instant meat product of this type at the consumer.

It has furthermore become apparent that more than 75% water could be bonded in the instant meat product according to the invention which was produced from fresh meat or ground meat with a water content of 68%-73%, without the water exiting from the rehydrated meat mass. From the rehydrated meat pieces or from the ground meat particularly juicy and sensory pleasant meat products, sauces, ragus or meatloaves could be obtained.

### Embodiment 1

The following ingredients were used as base materials for producing freeze-dried ground meat molded blanks:

| | |
|---|---|
| Fresh ground pork, category S1 | 100 kg |

Anti Oxidant Mix:

| | |
|---|---|
| plant oil (sunflower) | 900 g |
| Rosemary extract (Carnomaxx) | 40 g |

Dissolving the antioxidant mix in a fat phase with 10 minute stirring at room temperature; working the antioxidant mix into 4000 g of the ground meat; subsequently mixing with the rest of the ground meat.

Subsequently the ground meat provided with antioxidants is pre cooked in the cooking cutter in a reverse process at 90° C. for 20 minutes.

Then the precooked free rolling ground meat is applied to racks of the freeze dryer, wherein molded blanks with a greatest edge length of 3 cm-5 cm and a greatest height of 2 cm and 4 cm were formed.

Subsequently lowering the pressure in the drying chamber during freeze drying from ambient pressure within less than 10 minutes to approximately 1 mbar. The maximum heating plate temperature was 80° C., the drying time was approx. 8-12 hours, wherein the drying chamber of the freeze dryer was vented with nitrogen.

Eventually the freeze-dried ground meat molded blanks were packaged together with spices as ingredients under a protective gas atmosphere.

### Embodiment 2

For producing a ready to eat spaghetti Bolognese dish the following ingredients were used:

| | |
|---|---|
| Fresh ground pork Category S1 | 100 g |

Antioxidant Mix:

| | |
|---|---|
| Plant oil (sunflower) | 0.9 g |
| Rosemary extract | 0.04 g |

The antioxidant mix is dissolved in the fat phase with ten minute stirring at room temperature. Working the antioxidant mix into 40 g of the ground meat, subsequently mixing the ground meat with the rest of the ground meat. Subsequently the ground meat provided with antioxidants is pre cooked in the cooking cutter in a backward process at 90° C. for 20 minutes.

Then the precooked, freely rolling ground meat is applied to racks of the freeze dryer in a loose pour. In the context of the subsequent freeze drying the pressure in the drying chamber is reduced from atmospheric pressure within less than 10 minutes to approximately 1 mbar. The maximum heating plate temperature was 80° C.; the drying time was 8 hours, wherein the drying chamber of the freeze dryer was subsequently was vented with nitrogen.

The freeze-dried meat was mixed with precooked, freeze-dried spaghetti (185.3 g) and with a tomato spice mix (65.6 g).

In order to rehydrate the dry mix 800 ml of cold water was stirred in and the mix was heated to 95° C. for 5 minutes.

What is claimed is:

1. A method for producing a freeze-dried instant meat product, comprising the steps:
providing meat and optional additional ingredients; and
cooking, broiling, simmering, roasting or baking the meat in a pre-cooking process and then freeze-drying.

2. The method according to claim 1, wherein the pre-cooking process for the meat is performed so that a core temperature of the meat is 75° C. or less.

3. The method according to claim 1, wherein the meat is pork or beef and/or or poultry or fish.

4. The method according to claim 3, wherein before or after the pre-cooking process at least one antioxidant is introduced into a separate fat phase or amphiphile or lipophile phase, which represents an additional fat phase with respect to the intrinsic fat content already included in the meat and wherein the additional fat phase is mixed with the meat, worked into the meat or applied to the meat.

5. The method according to claim 4, wherein the amphiphile or lipophile phase includes oil, fat, alcohol or combinations from mono-/diglycerides.

6. The method according to claim 4, wherein the amphiphile or lipophile phase includes at least a portion of saturated fatty acids.

7. The method according to claim 4, wherein a natural or synthetic antioxidant is used as an antioxidant.

8. The method according to claim 7, wherein rosemary extract or alpha-tocopherol or gamma-tocopherol or vitamin c or carotene is used for the natural antioxidant.

9. The method according to claim 1, wherein the meat is broken down into ground meat before or after the precooking process.

10. The method according to claim 9, wherein the ground meat is filled into guts, shells or molds during the precooking process and cooked, broiled, simmered, roasted or baked in a vapor phase, hot air or water bath.

11. The method according to claim 9,
wherein the ground meat is formed into at least one ground meat molded blank after the pre cooking process, and
wherein a projection surface of a ground meat blank on a rack or on a tray of a freeze-dryer has a largest dimension of 2 cm to 16 cm and with respect to the rack, a greatest height of 1 cm to 4 cm.

12. The method according to claim 11, wherein ground meat molded blanks arranged on the racks have a mass in a range of 5 g to 1000 g before freeze drying.

13. The method according to claim 11, wherein a projection surface of the ground meat molded blank on the rack of the freeze dryer has a largest dimension from 3 cm to 5 cm and with reference to the rack a height of 2 cm to 4 cm.

14. The method according to claim 13, wherein ground meat molded blanks arranged on the rack have a mass in a range of 20 g to 100 g before freeze drying.

15. The method according to claim 11, wherein ground meat molded blanks arranged on the rack have a mass to surface ratio in a range of 1 kg/m² to 7 kg/m².

16. The method according to claim 11, wherein 0.5% to 1.4% by weight salt is added to the ground meat of at least one ground meat molded blank before molding and before freeze drying.

17. The method according to claim 11, wherein ingredients like spices, vegetables or additives are added to the ground meat of the at least one ground meat molded blank before molding and freeze drying.

18. The method according to claim 1, wherein the meat has a water content of 68%-70% before freeze drying.

19. The method according to claim 1, wherein the meat is freeze-dried in non-frozen condition or in frozen condition.

20. The method according to claim 1, wherein the freeze drying is performed so that the meat has a water content of less than 5% by weight after freeze drying.

21. The method according to claim 20, wherein the freeze drying if performed so that the meat has a water content of less than 3% by weight after freeze drying.

22. The method according to claim 1, wherein the freeze-dried meat is packaged under an exclusion of light and oxygen under a protective gas atmosphere into a vapor, oxygen and light proof packaging.

23. A freeze-dried instant meat product produced according to a method according to claim 1.

24. The freeze-dried instant meat product according to claim 23, wherein the water content of the freeze-dried meat is less than 5% by weight.

25. The freeze-dried instant meat product according to claim 24, wherein the water content of the freeze-dried meat is less than 3% by weight.

26. The freeze-dried instant meat product according to claim 24 the meat protein content of the freeze-dried meat is greater than 75% by weight.

27. The freeze-dried instant meat product according to claim 26, wherein the meat protein content of the freeze-dried meat is greater than 85% by weight.
